(19) United States
(12) Patent Application Publication
(10) Pub. No.: US 2014/0075393 A1
(43) Pub. Date: Mar. 13, 2014

(54) Gesture-Based Search Queries

(71) Applicants: Tao Mei, Beijing (CN); Jingdong Wang, Beijing (CN); Shipeng Li, Palo Alto, CA (US); Jian-Tao Sun, Beijing (CN); Zheng Chen, Beijing (CN); Shiyang Lu, Strathfield (AU)

(72) Inventors: Tao Mei, Beijing (CN); Jingdong Wang, Beijing (CN); Shipeng Li, Palo Alto, CA (US); Jian-Tao Sun, Beijing (CN); Zheng Chen, Beijing (CN); Shiyang Lu, Strathfield (AU)

(73) Assignee: Microsoft Corporation, Redmond, WA (US)

(21) Appl. No.: 13/609,259

(22) Filed: Sep. 11, 2012

(51) Int. Cl. G06F 3/033

(52) U.S. Cl. 715/863

(57) ABSTRACT

An image-based text extraction and searching system extracts an image be selected by gesture input by a user and the associated image data and proximate textual data in response to the image selection. Extracted image data and textual data can be utilized to perform or enhance a computerized search. The system can determine one or more database search terms based on the textual data and generate at least a first search query proposal related to the image data and the textual data.

### BACKGROUND

Historically, online searching has been conducted by allowing a user to enter user-supplied search terms in the form of text. The results of the search were highly dependent on the search terms entered by the user. If a user had little familiarity with a subject, then the search terms supplied by the user were often not the best terms that would produce a useful result.

Moreover, as computing devices have become more advanced, consumers have begun to rely more heavily on mobile devices. These mobile devices often have small screens and small user input interfaces, such as keypads. Thus, it can be difficult for a consumer to search via the mobile device because the small size of the characters on the display screen make entered text difficult to read and/or the keypad is difficult or time consuming to use.

### SUMMARY

Implementations described and claimed herein address the foregoing problems by providing image-based text extraction and searching. In accordance with one implementation, an image can be selected by a user, and the associated image data and proximate textual data can be extracted in response to the image selection. For example, image data and textual data can be extracted from a web page by receiving a gesture input from a user who has select an image on the web page (e.g., by circling the image using a finger or stylus on a touch screen interface). The system then identifies the associated image data and the textual data located proximate to the selected image.

In accordance with another implementation, the extracted image data and textual data can be utilized to perform a computerized search. For example, one or more search options can be presented to a user based on the extracted image data and the extracted proximate textual data. The system can determine one or more database search terms based on the textual data and generate at least a first search query proposal related to the image data and the textual data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example of generating textual data from a user-selected image that can be used in enhancing search options available to a user.

FIG. 2 illustrates example operations performed in a system that allow enhanced searching to be performed based on image data selected by a user.

FIG. 3 illustrates example operations for determining textual data from an input image.

FIG. 4 illustrates example operations for formulating a computerized search based upon an image selected by a user.

FIG. 5 illustrates example operations for generating search query proposals based upon image data and textual data from proximate the image.

FIG. 6 illustrates example operations for reorganizing search results generated based upon image data and textual data.

FIG. 7 illustrates an example system for performing gesture-based searching.

FIG. 8 illustrates another example system for performing gesture-based searching.

FIG. 9 illustrates yet another example system for performing gesture-based searching.

FIG. 10 illustrates an example system that may be useful in implementing the described technology.

### DETAILED DESCRIPTION

Users of computing devices can use textual entry to conduct a search. For example, a search query can be formed by a sequence of textual words entered into a browser's text search field. The browser can then execute the search on a computer network and return the results of the text search to the user. Such a system works adequately when the consumer knows what he or she is looking for, but it can be less helpful when the user does not know a lot about the subject or item being searched. For example, the user may be searching for an article of clothing that he or she saw in a magazine advertisement but that is not readily identifiable by name. Moreover, the consumer may be searching for an item that the consumer cannot adequately describe.

Also, the data content that is presented to consumers is increasingly image-based data. Moreover, such data content is often presented to consumers via their mobile devices, such as mobile phones, tablets, and other devices with surface-based user interfaces. The user interfaces on these devices, particularly mobile phones, can be very difficult for the consumer to use when entering text. Entering text can be difficult because of the size of the keypads, and mistakes in spelling or punctuation can be difficult to catch because of the small size of the displays on these mobile devices. Thus, text searching can be inconvenient and sometimes difficult.

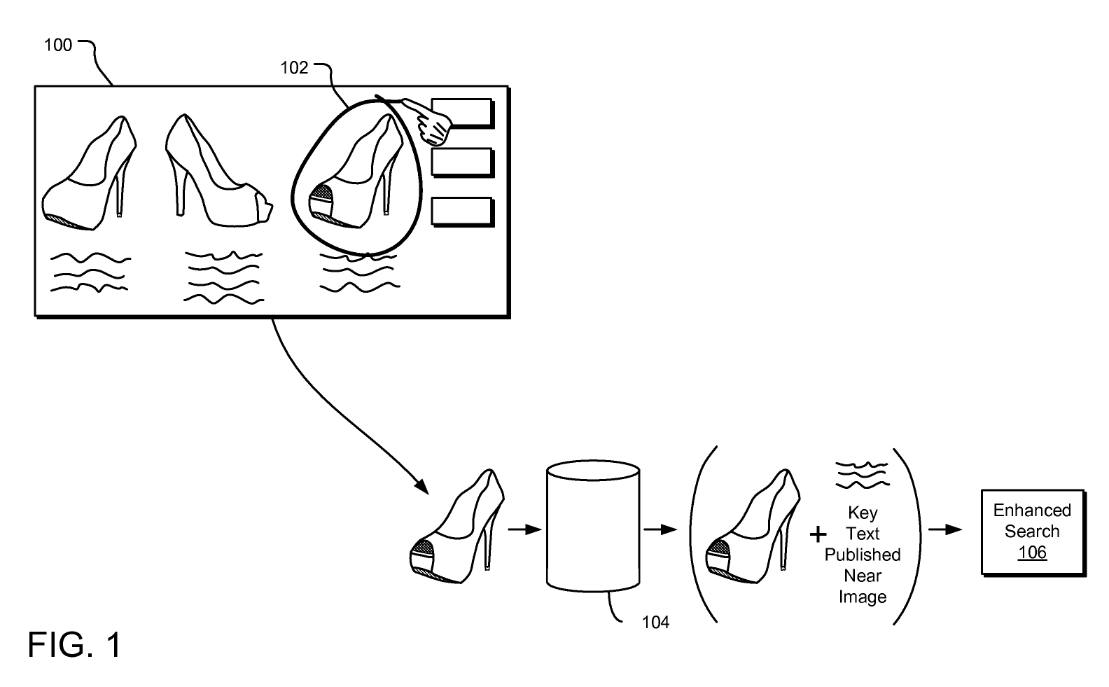

FIG. 1 illustrates an example of generating textual data from a user-selected image that can be used in enhancing search options available to a user. Using a system providing a user interface 100, a user can employ a gesture 102 to select an image being displayed in order to extract data about the image and contextual data from the text proximate to the image. Generally, a gesture refers to an input to a computing device in which one or more physical actions of a human are detected and interpreted by the computing device to communicate a particular message, command or other input to the computing device. Such physical actions may include camera-detected movements, touch-screen-detected movements, stylus-based input, etc. and may be combined with audio and other types of input. As shown in FIG. 1, the gesture 102 is represented by a circular tracing or “lasso” around an image on the device screen, although other gestures may be employed. In accordance with one implementation, text is considered proximate if a user or author would consider the text to be associated with the published image (e.g., based on its location relative to the published image). In an alternative implementation, the proximate data could be text taken from a pre-determined distance from the border of the image.

For example, a user can use a gesture referred to as a lasso to encircle an image displayed on a device. The computing device associated with the display treats the lasso as a gesture input that is selecting the displayed image, which can be accomplished, for example, using a surface-based user interface.

In FIG. 1, the user has utilized a surface-based user interface to circle a particular shoe displayed in the user interface 100. A computing device that is displaying the image can correlate the lasso to a particular part of the content being displayed. In FIG. 1, that content is the image of the shoe. Data identifying that image can be used as an input to a database in order to determine text or data that was associated with that image of the shoe in the display. In the example of FIG. 1, the text that is listed beneath the selected shoe image in the user interface 100 (i.e., identified as “key text published near image”) is determined by the system to be proximate to the shoe image and thus associated with the shoe image. As a result, the system can extract that proximate textual data, which can then be used in combination with the image of the shoe to provide enhanced search options (as represented by enhanced search 106), such as suggested search queries. Moreover, this gesture processing can be performed without the user ever having to type in any user-generated search terms. Rather, the user in this implementation can merely use a gesture, e.g., a lasso, to select an image of a shoe.

A database 104 shown in FIG. 1 can be located as part of the system displaying the image. Alternatively, the database can be located remotely from the display device. Moreover, an enhanced search can be performed by the display device or by a remotely located device.

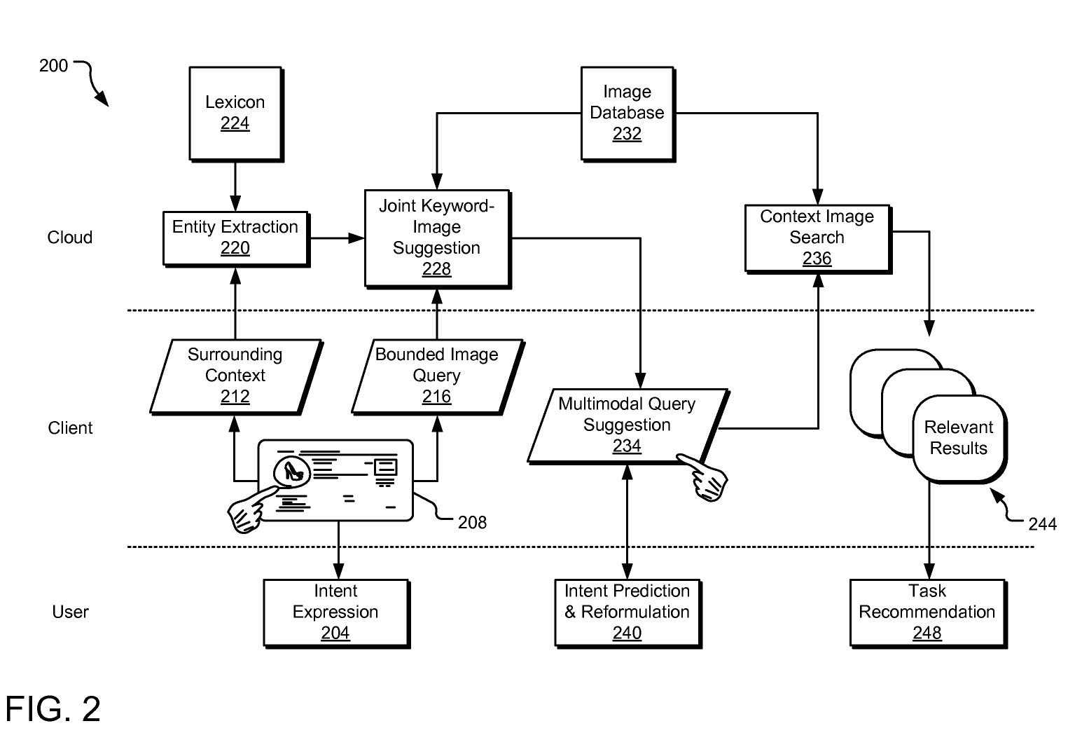

FIG. 2 illustrates example operations performed in a system 200 that allow enhanced searching to be performed based on image data selected by a user. Portions of the flow are allocated in FIG. 2 to the user (in the lower portion), the client device (in the middle portion), and to the server or cloud (in the upper portion), although various operations may be allocated differently in other implementations. A expression operation 204 indicates a user's expression of his or her intent, such as by a gesture-based input. Thus, as shown by user interface 208, a user has circled an image being presented in a user interface of a client device. In one implementation, the source of the image may be prepared content that the user downloads from the Web. Alternatively, the image may be a photograph that the user takes with his or her mobile device. Other alternatives are contemplated as well. The user may select (e.g., by a lasso gesture) the entire image or merely a portion of the image in order to search for more information related to the selected portion. In this particular implementation in FIG. 2, the device that is displaying the image can determine which image or portion of an image has been selected based on the user input gesture.

FIG. 2 shows that the client device can not only generate the bounded image query (query operation 216) but also can generate query data based on the surrounding contextual data, such as proximate textual data (contextual operation 212). As an alternative or in addition to the proximate textual data, the system may generate embedded keywords or metadata that are associated with the image but not necessarily displayed. Thus, the client device can determine which text or metadata is proximate or otherwise associated with the selected image. As noted above, such a determination can be made, for example, by using a database that stores image data and related data, such as related textual data associated with the displayed image. Other examples of related data include: image title, image caption, description, tags, text that surrounds or borders the image, text overlaid on the image, GPS information associated with the image, or other types of data, all of which may be generated by the contextual operation 212. If text is overlaid on the image, the contextual operation 212 can also extracted the text by utilizing optical character recognition, for example.

In one alternative implementation, the lasso input can be used to surround both an image and textual data. Additional textual data can also be extracted from outside the boundary of the lasso. The search to locate additional attributes can weight information related to the lassoed text more heavily than information related to text outside the lasso.

Once the selected image has been determined and the surrounding contextual data has been determined, the system 200 can generate one or more possible search queries. The search queries can be generated based on the extracted data and the selected image, or the extracted data and the image can first be used to generate additional search terms for the text search queries.

An extraction operation 220 performs entity extraction can be performed based on the contextual data generated by contextual operation 212. The entity extraction operation 220 can utilize the textual data that was proximate to the selected image and lexicon database 224 to determine additional possible search terms. For example, if the word “sandal” was published proximate to an image of a sandal, the entity extraction operation 212 may utilize the text “sandal” and the database 224 to generate alternative keywords, such as “summer footwear.” Thus, rather than proposing a search for sandals, the system 200 could propose a search for summer footwear.

Similarly, the selected image data can be sent to an image database to attempt to locate and further identify the selected image. Such a search can be performed in an image database 232. Once an image is detected in the image database 232, similar images can be located in the database. For example, if the user is searching for red shoes, the database can return not only the closest match to the user-selected image but also images corresponding to similar red shoes by other manufacturers. Such results might be used to form proposed search queries for searching for different models of red shoes.

In accordance with one implementation, a scalable image indexing and searching algorithm is based on a visual vocabulary tree (VT). The VT is constructed by performing hierarchical K-means clustering on a set of training feature descriptors representative of the database. A total of 50,000 visual words can be extracted from 10 million sampled dense scale-invariant feature transform (SIFT) descriptors, which are then used to build a vocabulary tree of 6 levels of branches and 10 nodes/sub-branches for each branch. The storage for the vocabulary tree in cache can be about 1.7 MB with 168 bytes for each visual word. The VT index scheme provides a fast and scalable mechanism suitable for large-scale and expansible databases. Besides the VT, one may also incorporate the image context around user-specified region of interest into the indexing scheme. One might utilize a large database with tens of millions of images. The dataset could be derived from two parts for example: a first from Flickr, which includes at least 700,000 images from 200 popular landmarks in ten countries, each image associated with its metadata (title, description, tag, and summarized user comments); and a second from a collection of local businesses from Yelp, which includes 350,000 user-uploaded images (e.g., food, menu, etc.) associated with 16,819 restaurants in twelve cities.

In addition to performing a search for an image and generating an output of possible images, the characteristics of those images can be utilized to propose a search query. For example, if all the images located in the search are shoes for women, the ultimate search query might be focused on items for women, rather than for items for both men and women. As such, the system 200 can not only extract data located proximate to an image, but also, the system 200 can utilize search results on the extracted data and search results based on the selected image to identify further data for use in a proposed search query.

Thus, in accordance with one implementation, different analyses can be performed to facilitate search query generation. For example, “context validation” allows extraction of the valid product specific attributes, and a large-scale image search allows similar images to be found in order to understand properties of a product from a visual perspective. Also, attribute mining allows attributes, such as the gender of a product, brand name, category name, etc. to be discovered from the prior two analyses.

After additional keywords and possible images are generated in this example, a suggestion operation 234 formulates and suggests one or more possible search queries that the user might want to make. For example, the system 200 might take a user-selected image of a tennis shoe and surrounding text data that indicated terms relating to tennis and use that data to generate proposed search queries for different brands of shoes for tennis. Thus, the system 200 might propose a search query to the consumer of “Search for shoes for tennis made by Nike?” or “Search for shoes for tennis made by Adidas?” or just “Search for shoes for tennis?”

Once the proposed search queries are presented to the user, a reformulation operation 240 presents the suggestions to the user and allows the user to re-formulate the searches, if appropriate. Thus, the user may reformulate one of the search queries listed above to read: “Search for shoes for racquetball made by Nike.” Alternatively, the user could simply select one or more of the formulated search queries if it was satisfactory for the user's intended purpose.

The proposed search queries can be formulated with image data as well. Thus, for example, an image(s) might be used to shop for a particular article of clothing. The image can be displayed to the user along with the proposed search query.

The selected search query can be implemented in the appropriate database(s). For example, an image search can be conducted in the image database. A textual search can be conducted in a text database. A search operation 236 performs a contextual image search after the user directs the selected or modified search to take place. In order to save time, all searches might be conducted while the user is thinking about which proposed search query to select. Then, the corresponding results can be displayed for the selected search query.

Once the user has selected a search query and the search results 244 for that search query have been generated, the search results can be sorted further. The search results 244 may be rearranged in other fashions as well (e.g., re-grouping, filtering, etc.).

For example, if the user is searching for an article of clothing, the search results can provide a recommendation 248 for various sites where the item of clothing can be purchased. In such an example, the task recommendation 248 is for the user to purchase the item from the site that offers the article of clothing for the lowest price.

Thus, as can be seen from FIG. 2, a natural interactive experience can be implemented for the user by 1) having the user explicitly and effectively express his or her intent by selecting an image; 2) having the client computing device capture the bounded image and extract data from the surrounding context of the image; 3) having a server re-formulate multi-modal queries by generating exemplary images and suggesting new keywords by analyzing attributes of the surrounding context; 4) having the user interact with the terms in the expanded queries which might capture his/her intent well; 5) having the system search based on the selected search query; and 6) re-organizing the search results based on the attributes generated from the user selected image in order to recommend a specific task.

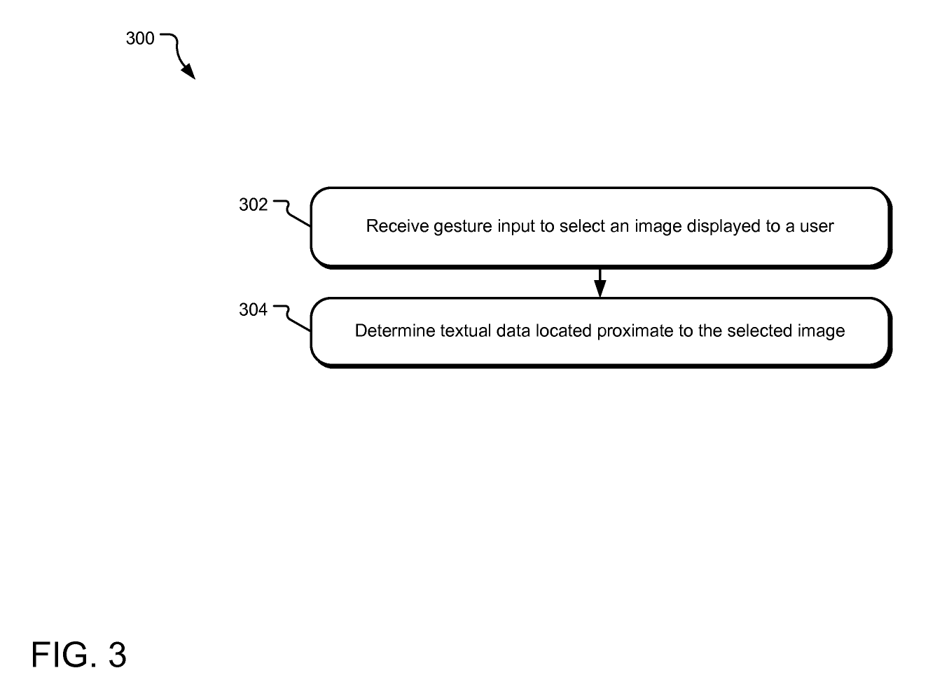

FIG. 3 illustrates example operations 300 for determining textual data from an input image. A receiving operation 302 (e.g., performed by a computing device operated by a user) receives a gesture input from the user. The gesture can be input via a user interface to the device. For example, the gesture can be input via a surface interface for the device. The gesture can be utilized to select an image displayed to the user. Moreover, the gesture can be utilized to select a portion of an image displayed to the user. A determining operation 304 determines the textual data located proximate to the selected image. Such textual data might include text that surrounds the image, metadata associated with the image, text overlaid on the image, GPS information associated with the image, or other types of data that is associated with the particular displayed image. This data can be used to perform an enhanced search.

In one alternative implementation, one can allow a user to select an image. The image is searched on an image database. The top result of the search is hopefully the selected image. Regardless of whether it is, however, the metadata for the search result is explored to extract keywords. Those keywords can then be projected on a pre-computed dictionary. For example, the Okapi BM25 ranking function may be used. The text-based retrieval result may then be re-ranked.

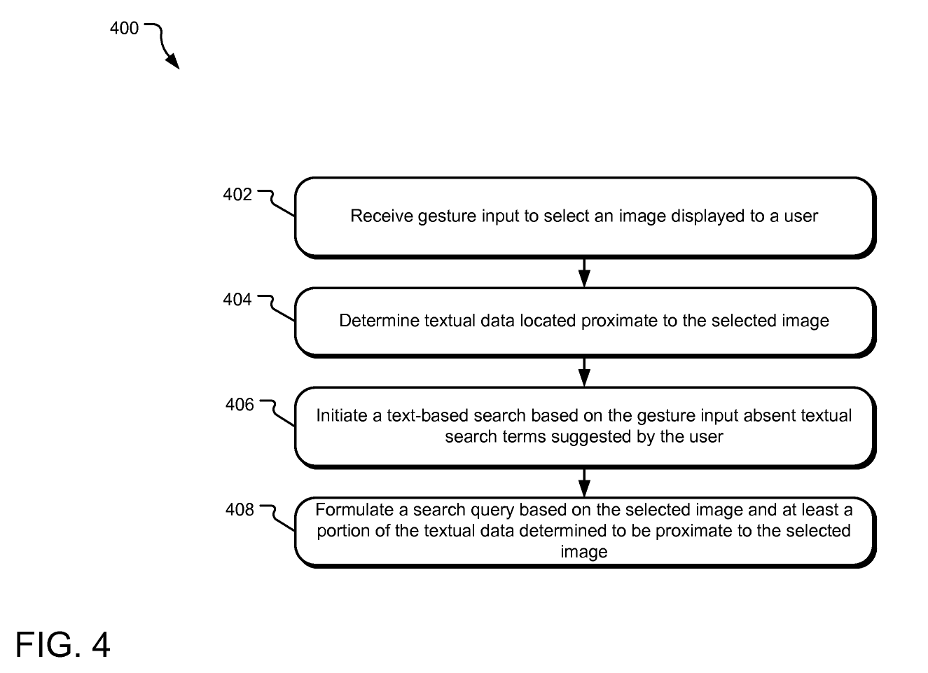

FIG. 4 illustrates example operations 400 for formulating a computerized search based upon an image selected by a user. An input operation 402 receives gesture input from a user via a user interface of a computing device. The gesture input can designate a particular image or a portion of a particular image. A determining operation 404 determines textual data located proximate to the selected image (e.g., the computing device that is displaying the image can determine the textual data). For example, the textual data could be determined from HTML code associated with an image as part of a web page. Alternatively, a remote device, such as a remote database, could determine the textual data located proximate to the selected image. For example, a content server could be accessed and the proximate textual data could be determined from a file on that content server.

A search operation 406 initiates a text-based search as a result of the gesture input without the need for the user to supply any user-generated search terms. A formulation operation 408 formulates a computerized search using the image selected by the user's gesture and at least a portion of textual data determined to be associated with the selected image.

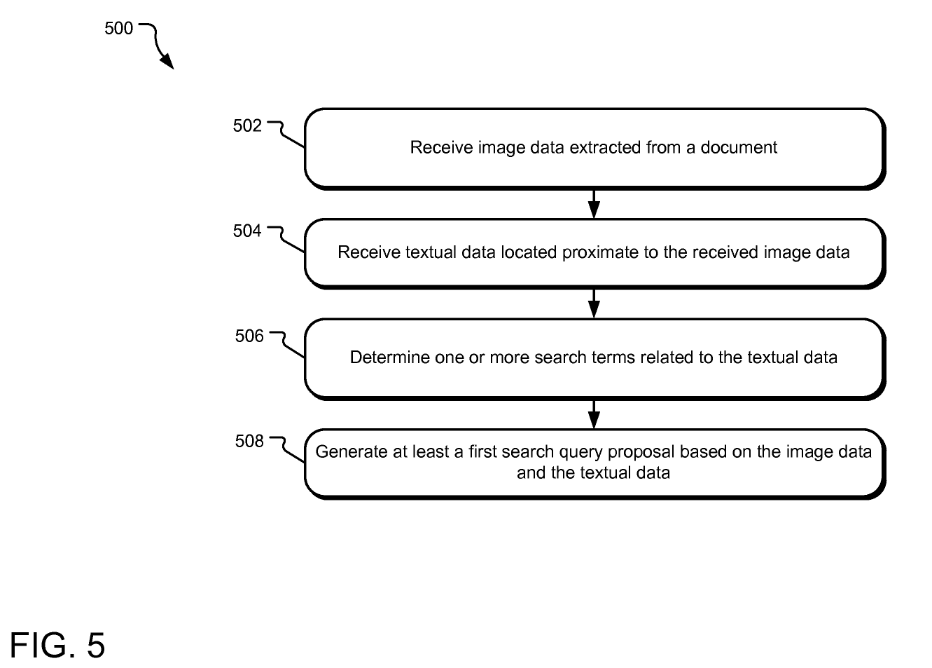

FIG. 5 illustrates example operations 500 for generating search query proposals based upon image data and textual data from proximate the image. The illustrated implementation depicts generation of a search query based on 1) input image data and 2) textual data located proximate to the image in the original document. A receiving operation 502 receives image data extracted from a document. A receiving operation 504 receives textual data that is located proximate to the image data in a document. A determining operation 506 determines one or more search terms related to the textual data. A generating operation 508 utilizes the image data and textual data is to generate in a computer at least a first search query proposal related to the image data and the textual data.

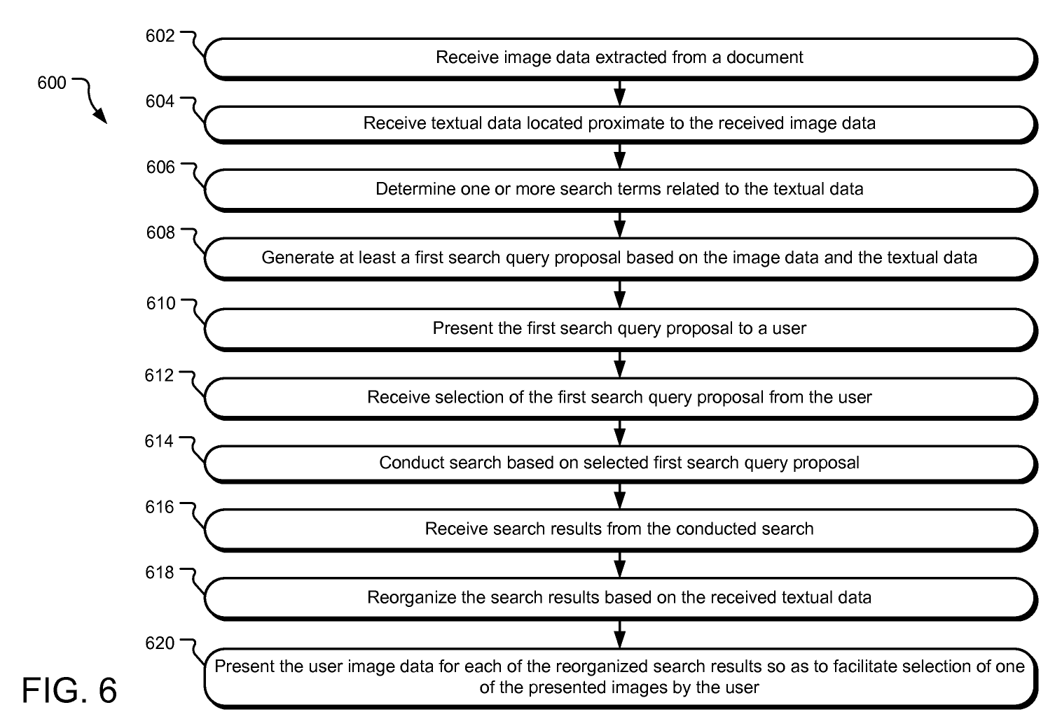

FIG. 6 illustrates example operations 600 for reorganizing search results generated based upon image data and textual data. A receiving operation 602 receives image data extracted from a document. Another receiving operation 604 receives textual data located proximate to the image in the image data. A determining operation 606 determines one or more additional search terms that are related to the textual data. The determination operation 606 may also determine one or more additional search terms that are related to the image data. Similarly, the determination operation 606 may also determine one or more additional search terms that are related to both the textual data and the image data.

A generating operation 608 uses the image data and textual data to generate in a computing device at least a first search query proposal that is related to the image data and to the textual data. In many instances, multiple different search queries can be generated to provide different search query options to the user. A presenting operation 610 presents the one or more proposed search query options to a user (e.g., via a user interface on a computing device).

A receiving operation 612 receives a signal from the user (e.g., via a user interface of the computing device), which can be utilized as an input to indicate that the user has selected the first search query proposal. If multiple search queries are proposed to the user, the signal may indicate which of the multiple queries the user selected.

Alternatively, the user can modify a proposed search query. The modified search query can be returned and indicated to be the search query that the user wants to search.

A search operation 614 conducts a computer-implemented search corresponding to the selected search query. Once the search results from the selected search query are received, as shown by a receiving operation 616, the search results can be reorganized, as shown by a reorganizing operation 618. For example, the search results can be reorganized based on the original image data and original textual data. Moreover, the search results may be reorganized based on the enhanced data generated from the original image data and the original textual data. The search results may even be reorganized based upon a trend noted in the search results and the original search information. For example, if the original search information indicates a search for a particular type of shoe but does not indicate the likely gender associated with the shoe and if the search results returned from the search indicate that most of the search results are for women's shoes, the search results can be reorganized to place the results that are for men's shoes further down the result list, as representing results that are less likely being of interest to the user.

A presenting operation 620 presents the search results to the user (e.g., via a user interface of a computing device). For example, image data for each result in the set of organized search results can be presented via a graphical display to the user. This presentation facilitates selection of one of the search results or conveyed images by the user on the mobile device. In accordance with one implementation, the selection by the user might be for the user to purchase the displayed result or to perform further comparison-shopping for the displayed result.

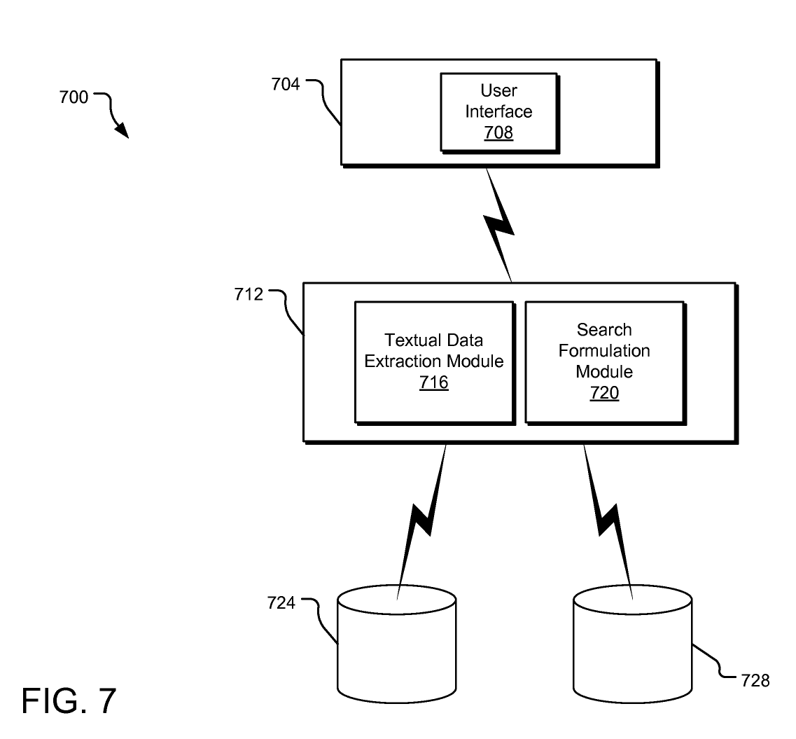

FIG. 7 illustrates an example system 700 for performing gesture-based searching. In system 700, a computing device 704 is shown. For example, computing device 704 could be a mobile phone having a visual display. The computing device is shown as having a user interface 708 that can input gesture based signals. The computing device 704 is shown as coupled with a computing device 712. The computing device 712 may have a textual data extraction module 716 as well as a search formulation module 720. The textual data extraction module allows the computing device 712 to consult a database 724 to determine textual data located proximate to a selected image. Thus, the textual data extraction module can receive as an input a selected image having image properties. Those image properties can be used to locate the document on a database 724 where the selected image appears. Text can be determined that is proximate to that selected image in the document.

A search formulation module 720 can take the selected image data and the extracted textual data to formulate at least one search query as described above. The one or more search queries can be presented via the computing device 704 for selection by a user. The selected search query can then be executed in database 728.

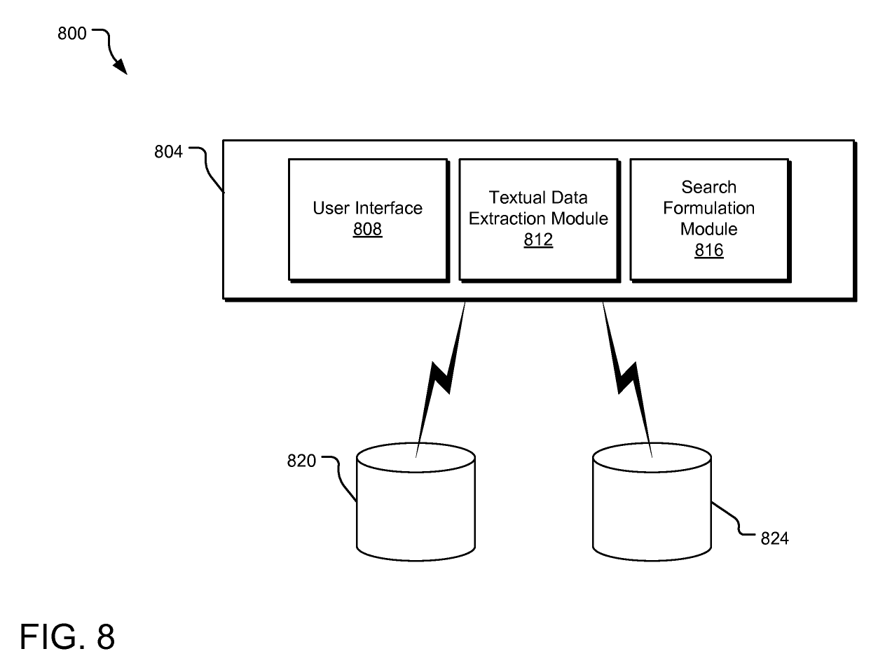

FIG. 8 illustrates another example system 800 for performing gesture-based searching. In system 800, a computing device 804 is shown having a user interface 808, a textual data extraction module 812, and a search formulation module 816. This implementation is similar to FIG. 7 except that the textual data extraction module and search formulation module reside on the user's computing device rather than on a remote computing device. The textual data extraction module can utilize database 820 to locate the file where the selected image appears or the textual data extraction module can utilize the file already presented to computing device 804 in order to display the original document. The search formulation module 816 can operate in similar fashion to the search formulation module shown in FIG. 7 and can access database 824 to implement the ultimately selected search query.

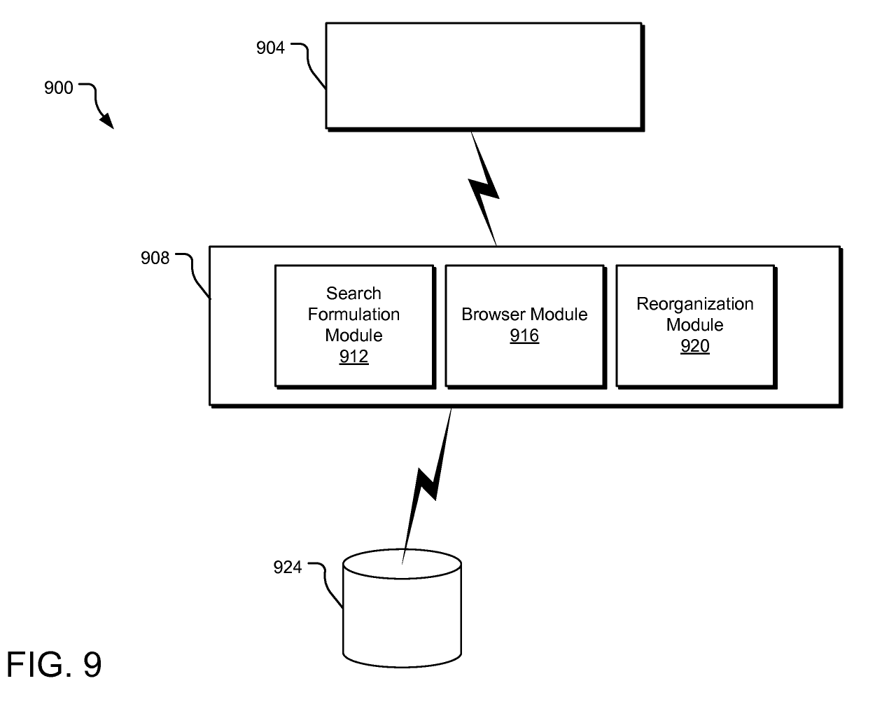

FIG. 9 illustrates yet another example system 900 for performing gesture-based searching. A user-computing device 904 is shown where an image can be selected. The corresponding image can be presented to the user via a computing device 908. As noted in the implementations described above, textual data and additional potential search terms can be generated by using the selected image as a starting point. A computing device 908 can utilize a search formulation module 912 to formulate possible search queries. A browser module 916 can implement a selected search query on database 924, and a reorganization module 920 can reorganize the search results that are received by the browser module. The reorganized results can be presented to the user via the user's computing device 904.

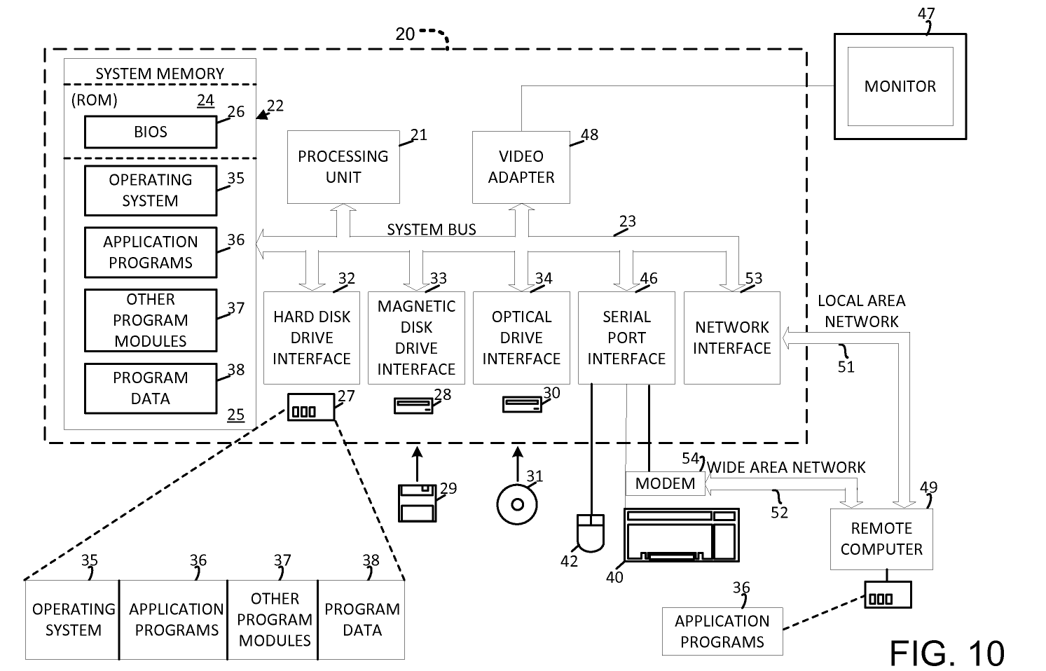

FIG. 10 illustrates an example system that may be useful in implementing the described technology. The example hardware and operating environment of FIG. 10 for implementing the described technology includes a computing device, such as general purpose computing device in the form of a gaming console or computer 20, a mobile telephone, a personal data assistant (PDA), a set top box, or other type of computing device. In the implementation of FIG. 10, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 10. The logical connections depicted in FIG. 10 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

A variety of applications lend themselves to image based searching. For example, image based searching is expected to be particularly useful for shopping. It should also be useful for identifying landmarks. And, it will have applicability for providing information about cuisine. These are but a few examples.

In an example implementation, software or firmware instructions for providing a user interface, extracting textual data, formulating searches, and reorganizing search results, and other hardware/software blocks stored in memory 22 and/or storage devices 29 or 31 and processed by the processing unit 21. The search results, image data, textual data, lexicon, storage image database, and other data may be stored in memory 22 and/or storage devices 29 or 31 as persistent datastores.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A method comprising:
receiving a gesture input via a user interface of a computing device to select an image displayed via the user interface; and
identifying textual data located proximate to the selected image.

2. The method of claim 1 further comprising:
formulating a computerized search based on the selected image and at least a portion of the textual data determined to be proximate to the selected image.

3. The method of claim 1 wherein the identifying operation comprises:
utilizing the computing device displaying the image to determine the textual data located proximate to the selected image.

4. The method of claim 1 wherein the identifying operation comprises:
accessing a database remote from the computing device; and
identifying the textual data located proximate to the selected image based on data from the database.

5. The method of claim 1 further comprising:
interpreting the gesture input as selecting a portion of a larger image.

6. The method of claim 1 further comprising:
initiating a text-based search as a result of the gesture input without any textual search terms being entered via the user interface.

7. The method of claim 1 further comprising:
determining additional search terms based on the image data.

8. The method of claim 1 and further comprising:
determining additional search terms based on the textual data located proximate to the image data.

9. One or more computer-readable storage media encoding computer-executable instructions for executing on a computer system a computer process, the computer process comprising:
receiving a gesture input via a user interface of a computing device to select an image displayed via the user interface; and
identifying textual data located proximate to the selected image.

10. The one or more computer-readable storage media of claim 9 wherein the computer process further comprises:
formulating a computerized search based on the selected image and at least a portion of the textual data determined to be proximate to the selected image.

11. The one or more computer-readable storage media as claimed in claim 9 wherein the identifying operation comprises:
utilizing the computing device displaying the image to determine the textual data located proximate to the selected image.

12. The one or more computer-readable storage media as claimed in claim 9 wherein the identifying operation comprises:
accessing a database remote from the computing device; and
identifying the textual data located proximate to the selected image based on data from the database.

13. The one or more computer-readable storage media as claimed in claim 9 wherein the computer process further comprises:
interpreting the gesture input as selecting a portion of a larger image.

14. The one or more compute-readable storage media as claimed in claim 9 wherein the computer process further comprises:
initiating a text-based search as a result of the gesture input without any textual search terms being entered via the user interface.

15. A system comprising:
a computing device presenting a user interface and being configured to receive a gesture input via a user interface of a computing device to select an image displayed via the user interface; and
a textual data extraction module configured to identify textual data located proximate to the selected image.

16. The system of claim 15 further comprising:
a search formulation module configured to a computerized search based on the selected image and at least a portion of the textual data determined to be proximate to the selected image.

17. The system of claim 15 wherein the textual data extraction module is disposed as part of the computing device displaying the image.

18. The system of claim 15 wherein the textual data extraction module is further configured to access a database remote from the computing device and to identify the textual data located proximate to the selected image based on data from the database.

19. The system of claim 15 wherein the computing device is further configured to interpret the gesture input as selecting a portion of a larger image.

20. The system of claim 15 further comprising:
a search module configured to initiate a text-based search as a result of the gesture input without any textual search terms being entered via the user interface.
